(19) United States
(12) Patent Application Publication
(10) Pub. No.: US 2014/0265906 A1
(43) Pub. Date: Sep. 18, 2014

(54) METHODS AND APPARATUS FOR LIGHTING EFFECTS IN A MOVING MEDIUM

(71) Applicant: EMAZING LIGHTS, LLC, West Covina, CA (US)

(72) Inventors: Brian Lim, West Covina, CA (US); Ramiro Montes de Oca, West Covina, CA (US)

(73) Assignee: EMAZING LIGHTS, LLC, West Covina, CA (US)

(21) Appl. No.: 14/217,117

(22) Filed: Mar. 17, 2014

Related U.S. Application Data
(60) Provisional application No. 61/800,834, filed on Mar. 15, 2013.

(51) Int. Cl. A41D 19/015; H05B 33/08

(52) U.S. Cl. CPC A41D 19/0157; H05B 33/0815
USPC 315/210; 362/103

(57) ABSTRACT

A device for creating moving light effects has a light source that is configured to pulse a light ON and OFF according to a desired pattern so as to create a moving light effect that is visible when the light source is moved. Some such devices can be programmed to custom-select color sets that are pulsed ON and OFF according to the desired pattern. Other such devices enable the user to custom select one or more patterns. Some devices can control a duty cycle of and LED of the light source by applying an eight bit octet over each duty cycle time in which the LED is pulsed ON or OFF based on a binary “1” or “0” of the octet. A microlight for use in artistic moving light shows such as gloving can employ such moving light effects, and some such microlights can be operated and programmed using a single actuator button.

### CROSS-REFERENCE TO RELATED APPLICATION

The application claims priority to U.S. Provisional Application No. 61/800,834, which was filed Mar. 15, 2013, the entirety of which is hereby incorporated by reference.

### BACKGROUND

The present disclosure relates to light emitting diode (LED)-based lights adapted for use in creating moving light effects. Several embodiments relate to LED-based microlights for use in moving light effects such as by dance artists.

LEDs have many uses due to their compact size, efficiency, and ability to generate multiple colors. For example, it has become popular to use LEDs in light fixtures for residential and office use, and as light sources for illuminated signage or electronics such as televisions, and the like. LEDs can also be used for ornamental purposes, adding colorful lighting effects to decorate rooms and buildings.

Artists have recognized the versatility of LEDs and included them in some art forms. For example, “gloving” is a dance-like art in which an artist wears gloves having LEDs at or near the tip of one or more of the artist's fingers. By moving his or her hands in specific ways, the gloving artist creates interesting moving light effects, often in conjunction with a musical background. Typically, the LEDs flash on and off according to a specified pattern, and the gloving artist uses the on/off flashing pattern when creating moving light effects.

Some pre-packaged LEDs include more than one diode. For example, an LED bulb may include a Red diode, a Green diode, and a Blue diode, that can be separately controlled. Such an “RGB” LED bulb can produce multiple colors, as the different-colored diodes can be programmed to flash for a longer or shorter time during each cycle, thus mixing the Red, Green and Blue light so that other colors are perceived. Gloving artists have also recognized that such an LED bulb can appear to be one color while held still, but upon moving the LED bulb quickly, the different combinations of colors become visible.

However, gloving artists have to work with serious limitations. For example, glovers wish to avoid bulky lights, preferring “microlights” that can fit on the ends of their fingers. Also, such microlights, to be effective, must not be complex to use during a performance. Further, glovers find limitations in the timing and routines that are available using such microlights, and have been limited in their ability to vary the on/off timing of LED bulbs.

Further, it is sometimes desired to use, for example, an RGB bulb to create another color. Historically this has been accomplished by varying the pulse width modulation of each diode within the RGB bulb. Thus, each diode may be flashing, even when the bulb is in an “on” period. While this method generally creates good color mixes when the LED bulb is stationary, sometimes when the bulb is moved the flashing can be detected by the human eye, leading to a low-quality lighting experience. This issue exists not only with artistic events such as gloving, but also in other moving light effects, and even in moving industrial products that may or may not use LEDs in color mixing, but will use pulse width modulation to control, for example, LED brightness (such as automotive tail/brake lights).

### SUMMARY

Accordingly, there is a need in the art for a compact LED-based lighting device configured to be programmable between one or more mode patterns and various color sets. There is a further need in the art for such a compact device that can be operated and programmed using the same, single button. There is a further need in the art for improved management of duty cycle in LED-based lighting devices so as to control LED duty cycle while minimizing or presenting perceptible color aberrations such as flicker when the LED-based lighting devices is operating while moving.

Improved management of light—color mixing w/o visible flashes when moved.

In accordance with one embodiment, a microlight for gloving is provided. The microlight comprises a casing configured to enclose a control chip having an integrated circuit and adapted to control a multicolor LED bulb. The casing is sized to fit within a glove and adjacent a fingernail of a user wearing the glove. The casing has a top surface, a bottom surface and a generally rigid shell portion. A flexible bottom member is provided at the bottom surface of the casing. The flexible bottom member is more flexible than the rigid shell portion and is configured to conform to a shape of a user's fingernail.

In some embodiments, the casing has a bottom aperture, and the flexible bottom member extends across and seals the bottom aperture.

In one such embodiment, the top and bottom flexible members comprise an elastomer. In some embodiments the top flexible member and the bottom flexible member are made of the same material. In other embodiment the bottom flexible member is more flexible than the top flexible member. In some such embodiments, the bottom flexible member has a coefficient of friction greater than a coefficient of friction of the top flexible member.

In some embodiments, the microlight comprises a plurality of pre-programmed modes, and the microlight comprises a routine for switching the microlight from a multi-mode operation, in which actuation of a button switches between the plurality of pre-programmed modes, to a one-mode operation, in which actuation of the button turns a single mode off and on.

In yet further embodiments, the microlight is programmable to have up to a maximum number of color sets, and each selected color can be selected to have one of at least two brightness levels.

In accordance with another embodiment, a method of controlling a duty cycle of an LED is provided. The method comprises determining a desired duty cycle ON time per cycle for the LED, dividing the ON and OFF time of the LED into at least one octet, the octet comprising 8 bits, each bit having a binary 1 corresponding to ON or a binary 0 corresponding to OFF. The total ON time of the octet corresponds to the desired ON duty cycle time. The method further includes pulsing the LED ON during bits having a binary 1 and OFF during bits having a binary 0.

Some such embodiments additionally comprise an operational database in which the binary octet is saved, and retrieving the saved binary pattern.

In some embodiments, if the desired duty cycle is less than 50%, no two adjacent bits have an ON setting.

Some embodiments additionally comprise providing a second LED having a duty cycle, and dividing the ON and OFF time of the second LED duty cycle into at least one octet. The octet comprises 8 bits, each bit having a binary 1 corresponding to ON or a binary 0 corresponding to OFF. The total ON time of the octet corresponds to the desired second LED ON duty cycle time. The method includes pulsing the second LED ON during bits having a binary 1 and OFF during bits having a binary 0. At least one of the bits of the second LED having a binary 1 is timed to occur at the same time as at least one of the bits of the first LED having a binary 0.

Some embodiments additionally comprise a table having a two digit hexadecimal code for each of the first and second LEDs. The first digit of the two-digit hexadecimal code corresponds to a hexadecimal number corresponding to a binary number representing the first binary nibble of the octet. The second digit of the two-digit hexadecimal code corresponds to a hexadecimal number corresponding to a binary number representing the second binary nibble of the octet.

### BRIEF DESCRIPTION OF THE DRAWINGS

FIG. 1 shows a perspective view of a glove for gloving, the glove accommodating LED-based microlights in finger portions;

FIG. 2 is a sectional view of the glove of FIG. 1 having a hand fitted therein and showing a sectional view of a microlight in a finger portion of the glove;

FIG. 3 is a close-up view taken along line 3-3 of FIG. 2;

FIGS. 4A-F show multiple views of an embodiment of a microlight;

FIGS. 5A-D show multiple views of the printed circuit board, LED and batteries of an embodiment of a microlight;

FIG. 6 is an exploded view of an embodiment of a microlight;

FIG. 7A is a bottom view of a bottom casing member according to an embodiment of a microlight;

FIG. 7B is a cross-sectional view taken along line 7B-7B of FIG. 7A;

FIG. 8A is a top view of a top casing member configured to fit with the bottom casing member of FIG. 7A;

FIG. 8B is a cross-sectional view taken along line 8B-8B of FIG. 8A;

FIG. 9 is a flow chart depicting one embodiment of a boot up routine for an LED-based microlight having features in accordance with one embodiment;

FIG. 10 is a flow chart depicting one embodiment of a time-click module configured to select differing functions based upon the length of time a microlight operating button is depressed by a user;

FIG. 11A is a table showing operational abilities of one embodiment of a microlight;

FIG. 11B is a table showing programmable color options for microlights in accordance with one embodiment;

FIG. 11C is a flow chart demonstrating an operation routine of the microlight whose operational abilities were listed in FIG. 11A;

FIG. 11D is a flow chart demonstrating an embodiment of a color set module routine in which users may program specific colors for an embodiment of a microlight;

FIG. 12A is a table showing operational abilities of another embodiment of a microlight;

FIG. 12B is a flow chart demonstrating an operation routine of the microlight of FIG. 12A;

FIG. 13A is a table showing operational abilities of another embodiment of a microlight;

FIG. 13B is a flow chart demonstrating an operation routine of the microlight of FIG. 13A;

FIG. 14A is a table showing operational abilities of another embodiment of a microlight;

FIG. 14B is a flow chart demonstrating an operation routine of the microlight of FIG. 14A;

FIG. 14C is a flow chart demonstrating one embodiment of a routine for custom programming options associated with an operating mode of the microlight of FIG. 14A;

FIG. 14D is a flow chart demonstrating an embodiment of a routine for setting colors for one or more modes of the microlight of FIG. 14A;

FIG. 15A is a table showing operational abilities of another embodiment of a microlight;

FIG. 15B is a flow chart demonstrating an operation routine of the microlight of FIG. 15A;

FIG. 15C is a flow chart demonstrating an embodiment of a routine for setting colors for one or more modes of the microlight of FIG. 15A;

FIG. 15D is a flow chart demonstrating a one-mode operational aspect of the microlight embodiment of FIG. 15A;

FIG. 15E is a table showing some example programming options for one of the modes of the microlight embodiment of FIG. 15A;

FIG. 16A is a schematic representation of LED on and off timing during a cycle according to pulse width modulation-based LED control;

FIG. 16B is a schematic representation of LED on and off timing during a cycle in accordance with another method of controlling the LEDs;

FIG. 17A is a schematic representation of LED on and off timing during a cycle according to pulse width modulation-based LED control;

FIG. 17B is a schematic representation of LED on and off timing during a cycle in accordance with another method of controlling the LEDs;

FIG. 18A is a schematic representation of LED on and off timing for red and green LEDs during a cycle according to pulse with modulation-based LED control and color mixing;

FIG. 18B is a schematic representation of LED on and off timing for red and green LEDs during a cycle according to another embodiment for controlling the LEDs for color mixing;

FIG. 19 is a table demonstrating certain color mixing recipes and binary and hexadecimal representations of Red, Green and Blue LEDs to produce the associated color;

FIG. 20 is a table listing colors by number, and the hexadecimal representation of pulse on and off time for each of the red, green and blue LEDs to mix the associated color;

FIG. 21 is a table listing the maximum colors associated with each of 5 modes in accordance with one, specific, exemplary embodiment;

FIG. 22A is a table listing colors associated with a mode in accordance with one, specific, exemplary embodiment;

FIG. 22B is a table showing the data of FIG. 22A but listing the hexadecimal codes associated with the colors in FIG. 22A;

FIG. 23 is a table showing the on and off timing associated with particular modes in accordance with one, specific, exemplary embodiment;

FIG. 24 is a table showing a sequence of events associated with one specific, exemplary embodiment; and

FIG. 25 is a flow chart showing more detail associated with the flow chart action item “play current mode”.

### DESCRIPTION

The present specification and figures present and discuss non-limiting embodiments of LED-based lighting devices and method and modes for programming and operating such devices. The technology and principles discussed herein are, in several embodiments, discussed in the context of microlights that are used in gloving artistry. While this application is included in the scope of invention, it is to be understood that the technologies and principles described herein can be used in other applications.

With initial reference to FIG. 1, a glove 50 is shown having five finger portions 52 (which includes a thumb portion), a cuff portion 54 and a hand portion 56. In the illustrated embodiment the glove 50 is cloth, stretchable, and/or permeable. The illustrated glove 50 is a left-handed glove. However, preferably embodiments will involve glove pairs including right and left-handed gloves. Also, various types and constructions of gloves are contemplated, including various semi-transparent, semi-opaque and woven gloves. In a preferred embodiment, the glove 50 is white. In other embodiments the glove can be other colors or even combinations of colors. For example, in a further embodiment the glove is black or otherwise dark-colored but with white or otherwise light-colored fingertips.

With additional reference to FIGS. 2 and 3, the illustrated glove 50 is stretchable so as to accommodate an LED microlight 60 in each finger portion 52 at and adjacent finger tips 62. More specifically, stretched projections 64 of the glove 50 accommodate the LED microlights 60. Such microlights 60 can be placed in some or all of the finger portions 52 as desired. In the illustrated embodiment, each of the microlights 60 is independent, and not physically connected to others of the microlights.

As best shown in FIGS. 2 and 3, a user's hand 66 can be placed within the glove 50 so that the user's finger 67 fills the corresponding finger portion 52. Each microlight 60 preferably sits atop a user's fingernail 68 within the glove 50 at the finger tip 62. The microlight 60 preferably includes a casing 70 that encloses a chip 75 and batteries 77 that power a prepackaged LED bulb 80. A bottom surface 82 of the casing 70 rests on the user's fingernail 68, and a top surface 84 of the casing 70 is adjacent the inside surface of the glove 50.

With reference next to FIGS. 4-8, the microlight casing 70 preferably comprises top and bottom casing members 86, 88 that engage one another to form the casing 70. As noted above, the chip 75 and batteries 77 are enclosed within the casing 70, with the LED bulb 80 extending forwardly from the casing 70. Preferably, the chip 75 comprises a printed circuit board 90 having a component side 92 and a battery side 94. A battery holder 100 comprises side portions 102 that connected to opposing edges of the circuit board 90 and a cross-member that extends between the side portions 102 and holds the battery or batteries 77 in place.

A circuit is formed on a component side 92 of the circuit board 90. The circuit preferably includes an integrated circuit 108 and an actuator button 110. The circuit provides a control circuit for the LED bulb 80, which is supported at a front edge of the circuit board 90.

With specific reference to FIGS. 5 and 6, the battery holder 100 can be configured to hold one or two batteries 77 securely, and can also hold batteries of different sizes securely, all while still fitting within the compact casing 70. In the illustrated embodiment, at or adjacent its connection to the side supports, the cross-member has a pair of opposing first inward bends 114, with inward meaning directed toward the battery side 94 of the circuit board 90. The cross member 104 also has a pair of opposing second outward bends 116, with outward meaning directed away from the battery side 94 of the circuit board 90. The second bends 116 are spaced radially from the first bends 114. A central portion 118 of the cross member 104 is defined between the second bends 116. In the illustrated embodiment, the first and second bends 114, 116 are configured to generally offset one another so that the central portion 118 of the cross member 104 is generally parallel to the circuit board 90.

In the illustrated embodiment, the length of the cross member 104 preferably is selected to be about the same as the width of the circuit board 90 between the side supports. As such, and as best depicted in FIGS. 5A-D, when a pair of full-size batteries 77 are disposed within the battery holder 100, the inward and outward cross member bends 114, 116 are fully deflected so that the cross member 104 is generally flattened or nearly flattened. In this orientation, the side supports are directed generally perpendicular to the circuit board 90. However, when the batteries 77 are removed and the cross member 104 is at rest, as depicted in FIG. 6, the inward and outward bends 114, 116 pull radially on the side supports so that the side supports bend toward a center of the circuit board 90, and are directed at an angle less than 90° relative to the circuit board 90.

With continued reference to FIGS. 5 and 6, preferably a tab 120 extends from the central portion 118 of the cross member 104. At or adjacent its connection to the cross member 104 the tab 120 has a first, inwardly-directed bend 122, creating an inwardly-directed portion 124. A second, outwardly-directed bend 126 transitions the inwardly-directed portion 124 to an outwardly-directed portion that terminates in a tab tip 128. As shown, the second bend 126 operates over a greater angle than the first bend 122 so that the tab tip 128 is spaced outwardly from the second bend 126.

In the illustrated embodiment, the bends 114, 116 of the cross member comprise a first biasing stage, and the bends 122, 124 of the tab 120 comprise a second biasing stage. As shown, the second biasing stage depends from and moves with the first biasing stage. The illustrated stages each preferably depend toward the circuit board 90 a distance of between about ⅕-⅓ of the length of the side supports 102 so that the total at-rest bias of the battery holder 100 is between about 0.4-0.7 of the length of the side supports.

In the illustrated embodiment, a conductive portion (not shown) is disposed on the battery side 94 of the circuit board 90 so as to engage the anode (−) side of the adjacent battery. The conductive portion communicates with the control circuit. The side and cross members 102, 104 preferably are formed of a conductive material such as metal. At least one of the side portions 102 is also connected to the control circuit, and the cross member 104 engages the cathode (+) side of the batteries 77 so as to provide power across the control circuit. In some embodiments a non-conductive insulator is disposed about the side portions 102.

With continued reference to FIGS. 4-8, the top and bottom casing members 86, 88 attachably engage one another to form the casing 70. As shown in FIGS. 4A-F, the casing members 86, 88 preferably meet at a seam 130. One or both of the top and bottom casing members 86, 88 can have a rear access cavity 132 so that a rear access window 134 is formed when the casing members 86, 88 are assembled. The rear access window can be used by a user to obtain sufficient purchase to separate the casing members 86, 88 so as to open the casing 70 to access the chip 75.

As best shown in FIGS. 7 and 8, preferably each of the top and bottom casing members 86, 88 comprise a hard or semi-hard shell 140, 142 that provides structural strength to the casing 70 and enables secure attachment of the top and bottom casing members to one another. In the bottom casing member 88, a bottom aperture 146 is formed through a bottom portion of the shell, and a bottom flexible member 150 extends across the bottom aperture 146. The bottom flexible member 150 makes up most of the bottom surface 82 of the bottom casing member 88. In the top casing member 86, a top aperture 156 is formed through a top portion of the shell 140, and a top flexible member 160 extends across the top aperture 156. The top flexible member 160 makes up most of the top surface 84 of the top casing member 86. A protrusion 162 depends from an inner surface of the top flexible member 160.

The protrusion 162 preferably is positioned so that it aligns with the actuator button 110 when the casing 70 is assembled with the chip 75. The top flexible member 160 readily deforms when pushed by, for example, a user's finger, and urges the protrusion 162 into contact with the actuator button 110. As such, the top flexible member 160 is configured so that the actuator button 110 can be readily and easily actuated upon application of a force to the top surface 84 of the casing 70.

The bottom flexible member 150 also readily deforms when placed atop the user's fingernail 68 within the glove 50. As such, the bottom surface 82 of the microlight casing 70 at least partially conforms to the shape of the user's fingernail, enabling a more secure placement of the microlight 60 on the user's fingernail 68. This helps resist undesired movement of the microlight 60 relative to the user's finger during use, and also enhances the ease of actuating the button 110, as the microlight 60 is less likely to move in response to actuation pressures.

In the illustrated embodiments, the top and bottom flexible members 150, 160 preferably also have increased friction properties (i.e., stickiness) relative to the hard shells 140, 142. As such, in addition to conformance to the fingernail, the bottom flexible member's 150 anti-slip frictional properties enhance secure placement of the microlight 60 and aid ease of button actuation. Also, the high-friction top flexible member 160 may better grip the adjacent glove material. Applicants have found that the high-grip ability of the bottom and top flexible members 150, 160 enables some users to selectively apply sufficient pressure between the glove inner surface and the user's fingernail so as to actuate the button without application of force from another source.

In the illustrated embodiment, the casing shells 140, 142 are formed of a rigid or semi-rigid material such as polycarbonate, and can be formed by various processes, such as injection molding. The flexible members 150, 160 preferably are formed of a material having elastomeric properties. In one embodiment, the flexible members 150, 160 are formed of a thermoplastic rubber (TPR) that is insert molded or overmolded with the corresponding shell 140, 142. In other embodiments, one or both of the top and bottom flexible members is formed of another thermoplastic elastomer (TPE) instead of TPR. It is to be understood, however, that several types of materials can be employed.

The top and bottom flexible members 150, 160 can be configured and sized in various manners. For example, in some embodiments the top and bottom flexible members can have about the same surface area. In other embodiments, the top flexible member can have a surface area greater than the bottom flexible member 150. In still further embodiments, the bottom flexible member can have a surface area greater than the top flexible member. In some embodiments, the top flexible member 160 has a surface area that is preferably at least six times the surface area of the actuator button 110, which arrangement Applicants have determined reduces bending and stretching of the top flexible member 160 during actuation, leading to easier and reliable button actuation upon application of pressure.

In some embodiments, the top and bottom flexible members 150, 160 are made of the same or similar materials. In another embodiment, the top and bottom flexible members 150, 160 have somewhat different properties, either by being formed of different materials or having a different thickness. For example, in one embodiment, the bottom flexible member is more flexible than the top member, leading to even greater conformance to the user's fingernail. In another embodiment, the bottom flexible member is formed of a material having greater friction properties (i.e., stickier) than the top flexible member. In additional embodiments, the bottom flexible member deflects more readily than the top flexible member. Such features enable the bottom flexible member to more readily conform to the user's fingernail. Preferably the top flexible member 160 has sufficient structural stiffness to maintain the protrusion 162 in position above the actuator button 110 when pressure is applied. The bottom flexible member 150 need not maintain such stiffness, and can be significantly more flexible than the top flexible member. For example, in some embodiments the bottom flexible member will deflect 1.3-2 times as far as the top flexible member when subjected to the same application of force.

In another embodiment, the bottom casing member may not have a bottom aperture 146. In one such embodiment, a flexible member, such as a layer of TPR, is applied to the bottom surface 82 of the bottom casing, even if there is no bottom aperture. As such, the flexible layer will still conform to the user's finger/fingernail, and increase friction and anti-slip properties, providing advantages to positioning and button actuation.

In still another embodiment, at least the bottom casing member can be made of a flexible material that conforms to the shape of the user's fingernail during use more than a rigid material such as polycarbonate.

As discussed above, gloving artists can use microlights to create interesting moving light effects. In some embodiments a microlight is preprogrammed to turn the LED on and off according to a pattern, and some embodiments include a set of colors. As such, the microlight displays a first color for an on time period, then is off for a off time period, then displays a second color for the on time period, followed by the off period, then displays a third color for the on period followed by the off period. The pattern then repeats itself. Such a repeating pattern is referred to as a “mode”. In some embodiments, the actuator button turns the microlight on to start the mode. Pressing the button again turns the microlight off.

There are several different modes, each having different on/off patterns. For example, a “strobe” mode has a pattern of 5 ms ON and 8 ms OFF, repeating for each programmed color. A “strobie” mode is a faster blinking mode, having for example a pattern of 3 ms ON and 23 ms OFF repeating for each programmed color, and a “hyper strobe” has a pattern of, for example, 17 ms ON and 17 OFF for each programmed color. Some mode patterns may be more complex. For example, a “strobe morph” mode combines 3 pre-programmed colors that are mixed over 24 steps with a strobe (5 ms ON/8 ms OFF) pattern for each color, and “X Morph” mode can also use three pre-programmed colors mixed over 96 steps of 3 ms ON with no OFF between colors. Other modes are also contemplated.

With reference next to FIG. 11A, one embodiment of a microlight program is summarized in a table. In this embodiment, the microlight is programmed to have three different modes, as indicated in the “Mode” column 250. In this embodiment, each mode is a different pattern, referred to as an “Option” in column 252. An “option” is a flashing pattern, equivalent to the term “mode” as described above. However, an “option” indicates that the user has a choice of mode pattern to use. As such, and as indicated in the table of FIG. 11A, mode 1 can be option “a”, which can be, for example, the “strobe” pattern; mode 2 can be option “b”, which can be, for example, the “strobie” pattern; and mode 3 can be option “c”, which can be, for example, the “hyper strobe” pattern. In the illustrated embodiment mode options a-c are preprogrammed into the microlight chip. Thus, the user can select operation of the microlight in accordance with one of the preprogrammed mode option patterns.

With reference next to FIG. 11B, the microlight embodiment allows the user to program a unique color set to be displayed by the microlight. The table of FIG. 11B shows a selection of colors available to the user, which colors are preprogrammed into the microlight's control circuit.

Referring now to FIG. 11C, a flow chart showing operation of the microlight of FIG. 11A is presented. Starting from OFF 300, pressing the button 302 turns on the microlight and can initiate running of a boot up routine as in FIG. 9. The pressed button preferably triggers running of a time-click module 200 that leads to different functions based on how long the button is depressed.

If a short click is detected at the time-click module 200, the light is set to mode 1 306 and then plays that mode as the current mode 308. Once the current mode 308 is initially played, a timer 310 begins to run. If the trigger time (here 3 seconds) passes 312 without the button being pressed 316, then the operation shifts so that any press of the button 314 turns the light off 300. However, if the button is pressed 316 before the trigger time passes, then the light operation shifts toward changing the mode. However, no action is taken until the button is released 318. Thus, if the user presses the button within the trigger time, but holds the button, the current mode will continue to play. Upon release of the button 318, the controller will check 320 to see whether the current mode is Mode 3, which is the last mode for the microlight in this embodiment. If the current mode is Mode 3, the light will turn off 300. However, if the current mode is not Mode 3, then the controller will set the current mode to be the next mode in order 321, and proceed to play the current mode 308 and start the loop again. As such, in any of the modes, if the user presses the button more than three seconds after the mode is initially played, the light will turn off, but in Modes 1 and 2, if the user presses the button within the three second trigger time, the current mode will continue to play, but upon release of the button the light will switch to the play the next mode.

As discussed above in connection with FIG. 11B, the user can use a default preprogrammed color set or can program her own color set from the preprogrammed colors. To program the color set, the user holds the button while turning the light on from the OFF 300 condition. When the click time module 200 indicates a “click hold”, the light plays a color set signal 322 which, in one embodiment, can be the light flashing 10 times and then displaying the first programmable color (here color #1—“white”). As noted above, during a click hold function the button is still being pressed when the operation exits the click time module 200. The timer continues running and determines whether within a trigger time (here 6 seconds) 324 the button is released 326. If the trigger time passes before the button is released, the light plays a default reset signal, such as the light flashing orange and then white ten times. The processor will then set the colors to a default, preprogrammed color set 330. Once the button is released 332, the light will be set to Mode 1 306, which is then played as the current mode 308, sending the light into its normal operational routine.

If, however, after the color set signal is played 322, the button is released 326 before the trigger time runs, the light enters a stage in which the user can custom program the color set. More specifically the process is sent 334 to a color set module 340 which includes a routine for enabling the user to set the colors. Once the colors are set in the color set module 340, the light is set to Mode 1, which is then played as the current mode 308, and the light returns to its normal operational routine.

An embodiment of the color set module 340 is presented in FIG. 11D. As shown, when the light enters the color set module 340, saved colors are cleared 342, and the “not finished programming” flag is set 344 (i.e., set to “1” or “true”). The processor then sets color memory slot 1 for programming, sets the display color to color #1 (here “white”) 348 and plays color 1 as the current color 350. The current color is played until the button is pressed 352, at which time the process enters a click time module 353, which selects the next function based on the length of time the button is pressed.

If the click time module 353 detects a short click, the processor indicates whether the displayed color is the last color (here, color #20) 354. If not, then the light is set to display the next color 356 and the process returns to the step of playing the current color 350. If, however, the last color is displayed at point 354, the process resets the color to color #1 at step 348 and the process begins again. It is to be understood that, rather than the specific inquiry at 354, the step of setting to the next color 356 can include going to color #1 if the current color was the last available color.

With additional reference to FIG. 11B, in the illustrated embodiment, color #2 is “blank”. If “blank” is selected as one of the colors of the color set, then the light will be OFF during the ON period corresponding to “blank”. In the illustrated embodiment, during the play current color 350 step when “blank” is the current color, the light will display light so that the user knows that the light is operating. However, preferably the displayed color will be characterized differently than other colors. For example, in the illustrated embodiment, for every actual color, the associated color is displayed continuously, but for “blank” a color is displayed as flashing. As such, the user knows that the flashing display indicates that “blank” is the current display color.

If the click time module 353 detects a click hold, the light plays a color select signal 358 such as, for example, the colored light flashing, and the current color is set in the open memory slot 360. Once the button is released 361, the process will inquire whether the memory slot that was just filled was the last color memory slot (here, the third slot) 362. If not, the open memory slot will be set to the next slot 364, the current color will be set to color 1 348, which will be played as the current color 350, and the process of selecting the next color will begin again. If, however, the slot that was just filled was the last color memory slot 362, the process will clear the “not finished programming” flag (turning it to “false” or “0”) and return to the regular operating routine 368, in which the light will be set to Mode 1 306 (see FIG. 11C), which will be played as the current mode 308. However, the light will be operating by playing the just-programmed colors as the color set displayed in the selected mode.

In a preferred embodiment, the programmed colors remain in memory when the light is turned off 300. Since the “not finished programming” flag was cleared, when the light is turned ON and goes through the boot up process of FIG. 9, the colors selected by the user will be saved and used during operation of the microlight.

With reference next to FIG. 12A, another embodiment of a microlight is represented by the operational abilities depicted in a table. In this embodiment, the mode can be custom-selected by the user as one of three options. For example, “a”, “b” and “c” can be different patterns (such as strobe, hyper strobe, etc.), and the user can select one of these mode options to play during operation of the microlight. In this embodiment, the user can also custom program the color set.

With reference next to FIG. 12B, while OFF 400, the light can be awakened by pressing the button 402, at which time a click time module 404 determines the next step based on how long the button is pressed. In the illustrated embodiment, the light comes with a default color set. In order to custom-program the color set, the user holds down the button upon initially pressing the button 402 to turn the light on from the off 400 state. When the click time module 404 detects a click hold, the light plays a color set signal 406, such as the light flashing 10 times and going to the first programmable color. Once the button is released 408, the operation proceeds 410 to a color selection module, such as the color selection module 340 of FIG. 11D. Once the user has selected the desired colors, the current mode and option is displayed 412.

If the user does not wish to custom set the colors, an initial short click of the button 402 when waking the light from the off 400 state prompts the light to play the current mode option 412, which may be a default, such as Option 1. The current mode and option will be played until the button is again pressed at 414. The light will then turn off 416. Click time module 418 evaluates how long the button is depressed. A short will return the microlight to the OFF state 400. However, a click hold will enable a user select one of the preset options to be displayed.

Upon detecting a click hold, the process will set the current option to Option 1 420, and play the current option for 3 seconds 422. If the button is not released 424 within that 3 second period, the next option will be set to the current option 426, and will be played for 3 seconds 422. This loop will continue until the button is released 424 while one of the options is being played. That option will then be set in the memory 428, and will be played as the current mode and option 412 as the light returns to normal operation. Preferably the option set in memory by the user in this process will remain the current option even if the light is turned off 400.

With reference next to FIGS. 13A and B, another embodiment of a microlight comes preprogrammed with three modes. In the illustrated embodiment, as indicated in the table of FIG. 13A, each mode has the same option, or pattern. However, preferably each mode can have its own color set. A default color set is provided with each mode. For example, in the illustrated embodiment, the default colors for Mode 1 are Red, Green and Blue; the default colors for Mode 2 are Blue, White and Green; and the default colors for Mode 3 are Purple, Yellow and Blue. In this embodiment, the user can customize the colors associated with each mode.

From an OFF condition 450, the light is wakened by pressing the button 452. A click time module 454 determines whether the user has made a short click or click hold. If a short click is detected, the light is set to mode 1 456, which is played as the current mode 458. The current mode is played until the button is pushed 460, at which time a click time module 462 determines the next step based on how long the button is pushed. Upon detecting a short click, the mode is set to the next mode 464, which is then played as the current mode 458. The operational cycle starts again.

If a click hold is detected by the click time module 462, the light is turned off 466 and the timer keeps track of how long the button is held. If the button is released 470 before a trigger time 468 passes, then the light remains off, and the microlight is placed in the OFF condition 450. However, if the trigger time 468 passes with the button still held down, a color set signal is played 472 and, once the button is released 474, the operation goes to a color set module 476 such as the color set module 340 discussed above. Once the user has programmed the colors in the color set module, the colors for that particular mode (and that mode only) are set in the memory, and the mode for which colors have just been custom-programmed is played as the current mode 458. Normal operation then continues.

Notably, the user can custom-program the color sets for one or more of the modes individually, and the color set for each particular mode remains in the chip memory.

The user can also take steps to restore the microlight to default colors. With continued reference to FIG. 13B, to return the color sets to the default, the user pushes the button 452 when the light is OFF 450, and holds the button down so that click time module 454 detects a long hold, at which time a restore default colors signal will be played 478, such as an orange flash. When the button is released 480 and the default colors will be restored 482, the current mode will be set to the first Mode 456, which will be played as the current mode 458, leading to normal operation of the microlight.

With reference next to FIGS. 14A-D, another embodiment of a microlight has even further versatility and programmability. In this embodiment, and as depicted in the table of FIG. 14A, up to eight modes are provided, each mode having its own color set. For each mode, one of 8 preprogrammed options (flashing patterns) can be selected by the user. Preferably each mode has a default color set, which is different than at least one other mode, and its own default pattern option. The table of FIG. 14A depicts an example of default colors associated with each preprogrammed mode. In the illustrated embodiment, the default option for Mode 1 is Option 1, the default option for Mode 2 is Option 2, and so on to the default option for Mode 8 being Option 8.

With specific reference next to FIG. 14B, in normal operation of this embodiment, the microlight is wakened from an OFF state 500 by pressing the button 502, at which time a click time module 504 determines how long the user holds the button. Upon detecting a short click, Mode 1 is set to be the current mode 506, which current mode is played 508 until the button is again pushed 510. Another click time module 512 determines the click time. If a short click is detected, the process determines whether the next mode exists 514. As discussed above, in this embodiment eight modes exist in the default condition. Thus, for all modes except Mode 8 in the default mode the next mode exists, and the current mode is set to the next mode 516, which is then played 508, resuming normal operation. If the next mode doesn't exist, Mode 1 is set as the current mode at 506, which is then played as the current mode 508.

If a click hold is detected at the click time module 512, the light is turned off 515. If the button is released 518 prior to passing of a trigger time (here 6 seconds) 517, the microlight is signaled to go to the off 520 and in fact goes to the OFF status 500. However, if the button is held longer than the trigger time 516, the processor is signaled to set the option 522, and thus proceeds to an option set module 525, in which the user selects which of the eight preprogrammed modules to associate with the current mode. Once the option is selected via the option set module 525, the current mode, which is programmed to the selected option is played at 508 and normal operation continues.

With reference next to FIG. 14C, an embodiment of the option set module 525 is depicted. As shown, during the option set routine, the display is first set to Option 1 as the current option 530. In the illustrated embodiment, Option 1 is the “3C Strobe” pattern. In other embodiments, Option 1 could preprogrammed at the factory to be any one of several patterns as desired. The current option is then played 532 for three seconds. As the user enters the option set module while the button is still being held down, the process inquires whether the button is released 534 while the current option is being played. If the button is not released 534 while the current option is being played, the processor determines whether the current option is the last option 536 (here, Option 8). If not, the next option is set to be the current option 538 and is played for three seconds 532. If the current option is the last option 538, the current option is reset to Option 1 at 530, which option is then played for three seconds 532.

If the button is released 534 while the current option during the playing time (here three seconds), the current option is set in memory as the option corresponding to the current mode 542, and the process returns to the normal operation 544. With reference again to FIG. 14B, the selected option is played as the current mode 528, and normal operation continues.

As noted above, the user can also change the colors associated with each mode, and can even limit the number of modes programmed, up to the maximum number of modes (eight in this embodiment). In order to custom program the modes, the user holds down the button after pressing the button 502 to wake the microlight from the OFF condition 500. When the click time module 504 detects a click hold, it plays a mode reset signal 550, such as 10 orange flashes. If the user releases the button 554 before a default reset trigger time 552, the process is signaled to set the modes 556, and proceeds to a mode set module 560.

With reference next to FIG. 14D once the process enters the mode set module 560, the light plays a mode set signal 562, such as a blinking orange light. Preferably the mode set signal 562 is different than the mode reset signal 550, and isn't played until after entering the mode set module 560. All mode color sets are cleared 564, and the “not finished programming” flag is set 568 (i.e., to “true”, or “1”). The process sets Mode 1 as the current mode for programming 568, and enters into the routine for programming the current mode color set 570, all while the mode set signal 562 continues to play. When the button is pressed 572, a click time module 574 determines the length the button is depressed. If a short click is detected by the click time module 574, the user has selected to set mode colors 576, and the process is sent to a color set module 340 such as that discussed above.

Once a color set has been selected in the color set module 340, the process determines whether the current mode is the last mode (here, Mode 8) at 578. If it is the last mode, the programming process is determined to be complete. Thus, the “not finished programming” flag is cleared 582, and the program proceeds to off 584. Thus, the program returns to normal operation at the OFF status 500, but with the modes custom programmed as desired by the user.

If, after the colors for the current mode are selected in the color set module 340, the current mode is not the last mode 578, then the next mode is opened 580 and set at the current mode. The mode set signal that was played at step 562 is again played 581, and the current mode is open for color setting at step 570 according to the routine as discussed.

With the mode set signal playing and the current mode open for programming, the user does NOT have to set colors for the current mode. In fact, the user can simply press and hold the button down to stop programming modes. More specifically, if the click time module 574 detects a click hold, there is an inquiry whether Mode 1 is the current mode 586. If not, the current mode is cleared 588, the “not finished programming” flag is cleared 582, mode programming is finished and the mode set module is exited 584, sending the microlight to the OFF status 500.

Notably, in the situation just discussed, since the modes were cleared earlier in the mode set module 560, the only modes remaining in operational memory are the modes that were specifically programmed by the user. For example, if only Modes 1 and 2 were programmed before the user held down the button and terminated mode programming, the microlight will have been transformed from its default, 8-mode configuration to its programmed 2-mode configuration, and its normal operation will function with only the two programmed modes. As such, the user can custom-program the number of modes provided by the microlight.

With reference again to FIG. 14D, if after the click time module 574 has detected a click hold the process notes that Mode 1 is the current mode 586, the mode set module 560 terminates and the process exits 584, taking the light to the OFF status 500. However, the “not finished programming” flag is not cleared. Thus, next time the button is pressed 502, as the light boots up and runs the boot up routine of FIG. 9, the default modes and colors will be restored because the not finished programming” flag was not cleared.

With reference again to FIG. 14B, if after the mode reset signal 550 has been played, the user continues to hold down the button 554 until after the default reset time trigger 552 passes, a default reset signal 590, such as 10 white flashes, is played, and the modes are reset to their defaults 592, including all 8 default modes, with default options and color sets. When the button is released 594, Mode 1 is set as the current mode 506, which is then played 508, and the microlight proceeds along its normal operation routine.

As discussed herein, the present operational routine enables the user to select any number of modes up to the maximum number, in the user's own preferred order, and using the user's own preferred colors.

With reference next to FIGS. 15A-E, another embodiment of a microlight is configured for improved versatility and programmability in some aspects. More specifically, the illustrated embodiment provides pre-programmed default modes, and enables the user to custom program as many colors as the user desires, up to a maximum. Further, in the illustrated embodiment, once a color has been selected, the user can select a brightness of the selected color between two or more levels of brightness. In the illustrated embodiment the user can select between three tints, or brightness levels. The table of FIG. 15A indicates the available brightness levels in the illustrated embodiment as H for high-brightness, M for medium-brightness and L for low-brightness, with underlining depicting the brightness level actually selected.

FIG. 15A also depicts the default modes and color sets provided in the illustrated embodiment. With reference next to FIG. 15B, to operate the microlight from an initial OFF status 600, the user pushes the button 602. A click time module 604 selects the next step based on the length of time the button is pressed. If a short click is detected, Mode 1 is set as the current mode 606, which is then played 608 until the button is again pushed 610. If the click time module 612 detects that the button push was a short click, the next mode is set as the current mode 614, which is then played in accordance with the normal operation loop just discussed. It is to be understood that if the mode is the last mode (i.e., Mode 5 in the illustrated embodiment), the next mode can be Mode 1.

If, during normal operation, the click time module 612 detects a click hold, the process enters a subroutine 620 in which a decision is made whether to move the microlight to OFF status 600, whether to go to a color set program for the current mode, or whether to switch to single-mode operation. Upon detecting the click hold, the light is turned off 622. If the button is released 626 before a trigger time 624, the microlight is moved to the OFF status 600. However if the button continues to be held through the trigger time 624, a color set program signal 628 is played, such as the light flashing orange. If the button is released 632 before a second trigger time 630 passes, the process is signaled to set the colors 634 for the current mode, and proceeds to a color set program module 636 as described in FIG. 15C.

With reference next to FIG. 15C, in the color set program module 636, the saved colors are cleared from the operating memory 638, and a first memory slot is set for programming 640. Also, the first color is set as the current color 642, which current color is played 64 until the button is pressed 646. If click time module 648 detects the button press to be a short click, the current color is set to the next color 650, which is then played 644 until the button is pressed 648. This loop routine continues until the user comes to the color the user desires, at which the user can hold the button long enough to be a long click, but then releases the button so that the click module 648 detects a long click. As a consequence of the long click, the current color is stored 652 in the open memory slot. The light then flashes the color saved in each selected slot in order 654. Thus, if only one color has been selected, only that color will be flashed at step 654. But if 6 colors have been selected, each of the six selected colors will be flashed, in order of selection, at step 654.

If at step 656 the current slot that has just been filled with a selected color is the last color slot (color slot 7 in the illustrated embodiment), then color programming is complete, and the process is sent back to main operation 658. However, if the color slot is not the last color slot, the current slot is set to the next slot 660, and the displayed color is again set to the first color 642 so that the user can select the next color.

In order to select different color tints, or brightness levels, the user holds down the button 646 until the click time module 648 detects a click hold, at which the processor will inquire 662 whether the current color is color #2, which in this embodiment is “blank”. If not, the current color is set to display 664 at color tint 1. Color tint 1 can be, for example, the “high” brightness level. The current color tint is played 666 for a time (here, 0.5 second). If the button is not released 668 while the current color tint is being played 666, the current color tint is set to the next color tint 670. This cycle is continued until the button is released 668 during display of one of the color tint levels. The color tint on display when the button is released is stored in the associated color slot 672 and, as discussed above, the light flashes the color of each selected slot in order at step 654. Programming of each color in the color set proceeds as discussed.

If the user wishes to not program the maximum number of colors, the user programs the one or more colors and color tints that are desired, and then short clicks until the current color is color #2 (“blank”), at which time the user holds down the button at step 646 until the click time module 648 detects the click hold. Since the current color is “blank”, 662, the process will close the current and subsequent unfilled memory slots 676, and flash the color of each selected slot in order of selection 678. The color set program module 636 will then terminate, returning to main operation 680. As shown in FIG. 15B, when returning to main operation 680, the current mode, for which colors have just been set, will be played 608 until the button is pushed 610.

With continued reference to subroutine 620 of FIG. 15B, if the button continues to be held down 632 beyond the second trigger time 630 after the color set program signal 628 has been played, the light will play a one-mode operation signal 682, such as the light flashing green. Once the button is released 684, the light will be set to one-mode operation 686, and will be signaled 688 to enter a one-mode operation module 690.

With reference next to FIG. 15D, in the one-mode operation module 690, the current mode is played 700 until the button is pushed 702. If a short click is detected by click time module 704, the microlight is turned to the OFF status 710. Pushing the button 712 will wake the microlight from the OFF status 710, and play the current mode, which cannot be changed while in one-mode operation.

To exit one-mode operation, the user pushes the button 702 and holds it so that a click hold is detected by the click time module 704. The process then enters the subroutine 620, in which it is decided whether to move the microlight to the OFF status 710, to enter the color setting program 634, or to switch operation mode. Switching operation mode from one-mode operation to regular, all-mode main operation mirrors the steps of subroutine 620 switching from all-mode normal operation to one-mode operation as discussed above and depicted in FIG. 15B. When the light is signaled to go from one-mode operation to main operation 680 as depicted in FIGS. 15D and 15B, the microlight resumes all-mode operation, and plays the current mode 608 that was being used in the one-mode operation.

With reference again to the table in FIG. 15A, each of the default modes has certain ON/OFF timing and features that are advantageous for certain moving light effects. In the illustrated embodiment, Mode 5, labeled “Chroma” mode is specially configured to play ON periods of each selected color with no OFF periods between colors. This configuration enables users to simulate and create several modes by custom programming the color set.

FIG. 15E depicts a table of example color sets associated with the Mode 5 “Chroma” mode. The Chroma default mode is the pattern preprogrammed as default in the microlight. The next four rows of FIG. 15E depict modes that can be created from the “Chroma” mode by careful color programming. For example, a “tracer” mode can be created in which a high-brightness Blue light is followed by two ON cycles of low-brightness Red light. When moving, this mode will appear as a Blue line weakly followed by a long, dim red line. The “Solid” sub mode can be programmed in the Chroma mode by selecting only a single color (here, red). As such, the moving light effect is a solid, unbroken line. In contrast, the “2C Hyper Strobe” sub-option employs Chroma mode to simulate a Hyper strobe employing only two colors. Specifically, while colors are selected for color slots 1 and 4, blanks (which appear as OFF periods) are selected for color slots 2, 3, 5 and 6. As such, even though the Chroma mode has no OFF time between color displays, use of the Blank colors creates a two color hyper strobe effect that displays a relatively-long OFF time between displayed colors.

Any one or more of a plurality of methods or routines can be employed to show selected colors at two or more tints, or brightness levels. For example, in one embodiment, the duty cycle of the LED can be manipulated to obtain a desired brightness level. In another embodiment, the integrated circuit can be configured to increase or decrease current flow and/or voltage applied to a desired one of the LEDs in order to manipulate brightness of the perceived color.

The embodiments discussed above in connection with FIGS. 9-15 present several microlight embodiments that involve variations in the features that are adjustable and the features that are preselected. And programming methods are provided so that the single microlight button can be used to program several features. Further, in the discussed embodiments, the LED-based device (here the microlights) can be programmed without requiring any input from any other device, such as a computer. As discussed, this is accomplished by assigning different meanings to button presses of different lengths. Also, as the time the button is depressed exceeds prescribed triggers, the options available when the button is released or, in some embodiments, pressed, change. Usually a visible signal indicates the coming and going of certain options, and the changing meanings of button actuation.

It is to be understood that Applicants anticipate other embodiments combining features of the specific embodiments described above. Additionally, it is anticipated that other embodiments may provide microlights, or other LED-based lighted devices, having some or all of the operational features discussed in embodiments but, for example, be amenable to programming in a different manner than using only a single button. For example, other LED-based devices may have sufficient room for more than one button, but the device may still be independently programmable without necessitating interaction from any outside device. In still other embodiments an LED-based device may programmable by an attachable computer.

The embodiments described above demonstrate different embodiments that may satisfy the needs and desires of certain artists for particular uses. Still, it is anticipated that some artists may use different embodiments for different moving light shows, and may wish to own more than one set of microlights, which different sets are configured differently. For example, an artist may desire one microlight set according to each of the embodiments depicted in FIGS. 11-15.

One manufacturer may make each of these six different models of microlights. Since each set has different features, the artist will not want to get them confused. However, preferably the chips of each set are substantially the same in shape, and will fit within a common-sized casing 70. Accordingly, in one embodiment, each model of microlight chip has a unique color applied to the chip. As such, even if microlights of different models and features are mixed together, the microlights can quickly be sorted into sets by grouping the chips of common color.

Preferably the casings 70 are clear, semi-opaque or translucent so that a user can detect the color of the chip 75 enclosed within the casing 70 so that sets of multiple chips 75 can easily be grouped together without the need to turn on the microlight.

As discussed above, the illustrated LED bulb preferably comprises multiple diodes of different colors (RGB in the illustrated embodiment). By varying the duty cycle, or ON time, of each colored diode during each cycle, the three colors can combine to create several different colors, such as the color options in the table of FIG. 11B. With reference to FIG. 16A, one way to vary the duty cycle of each diode is referred to as Pulse Width Modulation (PWM) in which the diode is in the ON state for a specified percentage of the time of each cycle (50% in the illustrated embodiment), and OFF for the remainder of each cycle.

The PWM approach can enable color mixing, and also control of tint or brightness of color emitted by the LED. Applicants have found that controlling LED duty cycle via PWM can produce quality effects when the light is at rest. However, when the light is moving, the relatively-long ON and OFF times of PWM-controlled LEDs can lead to color aberrations such as flickering, as moving the light may make the ON/OFF flashing of the LEDs visible, resulting in low quality color and moving light effects.

In another embodiment, each time cycle is presented as a byte, or octet, in which the cycle is digitally presented as 8 bits that are either “true” or “ON” as represented digitally by a 1, or “false” or “OFF”, as represented digitally by a 0. In this manner, and with additional reference to FIG. 16B, each bit of the octet, in succession, provides an ON or OFF instruction for the processor as time progresses through a cycle. Also, each of the 8 bits of the octet can be configured as ON or OFF in a manner so that the total ON time per cycle remains the desired amount (here, 50%), but the ON time is divided between four equally-spaced, short pulses rather than the long ON and OFF periods of PWM (see FIG. 16A). As such, ON and OFF periods can be better distributed across the cycle, making it less likely that each ON pulse can be perceived, even when the light is moving quickly. Quality of color mixing and the moving light effect is improved, as color aberrations such as flickering are minimized or eliminated. Also, as will be demonstrated below, by using octet instructions the diode can begin the cycle OFF and be pulsed ON as time passes, and successive bit instructions are executed.

Additionally, employing octets lends itself to decreasing processor time, as binary and hexadecimal codes can be employed in computer instructions. In order to facilitate further discussion, Table 1 below sets forth 0-15 in Base 10, the binary equivalent of 0-15, and the hexadecimal equivalent of 0-15.

| Base 10 | Binary | Hexadecimal |
|---|---|---|
| 0 | 0000 | 0 |
| 1 | 0001 | 1 |
| 2 | 0010 | 2 |
| 3 | 0011 | 3 |
| 4 | 0100 | 4 |
| 5 | 0101 | 5 |
| 6 | 0110 | 6 |
| 7 | 0111 | 7 |
| 8 | 1000 | 8 |
| 9 | 1001 | 9 |
| 10 | 1010 | A |
| 11 | 1011 | B |
| 12 | 1100 | C |
| 13 | 1101 | D |
| 14 | 1110 | E |
| 15 | 1111 | F |

With reference again to FIG. 16B, the ON/OFF period of the 8 bits in the illustrated octet can be depicted in binary as 10101010. Four bits of an octet are commonly referred to as a “nibble”. In this case, 10101010, is made up of two nibbles of “1010” joined end-to-end. The hexadecimal system is particularly efficient at depicting binary octet numbers. Specifically, the nibbles “1010” each correspond to “A” in the hexadecimal system. And the octet 10101010 can be depicted as 0xAA in hexadecimal. This becomes especially helpful in increasing processor efficiency in controlling LED pulses as octets.

With reference next to FIGS. 17A and 17B another example is given contrasting how a duty cycle of 25% can be provided by PWM (see FIG. 17A) and octet pulse (FIG. 17B). As depicted in FIG. 17B, the two ON pulses can be distributed across the octet, increasing the smoothness of light pulses as perceived during moving light effects. Also, the ON/OFF periods of the octet in FIG. 17B can be represented as the binary value 10001000, which corresponds to the hexadecimal representation 0x88.

With reference next to FIG. 18A, a color mixture is represented, in which both Red and Green LEDs are operated at a 50% duty cycle to create another color effect. In the illustrated PWM approach, both the Red and Green LEDs are continuously ON for the first 50% of the cycle time, and both are OFF for the remaining 50% of the cycle time.

FIG. 18B, however, depicts an embodiment of Red and Green LEDs operated at a 50% duty cycle employing an octet-based pulsing approach. In the illustrated embodiment, the Red diode is pulsed ON and OFF according to a pattern represented in binary as 10101010, and 0xAA in hexadecimal. The same pulsing pattern can be used for the Green diode in order to achieve the desired color mix. However, in the illustrated embodiment the Green diode is pulsed according to a pattern represented in binary as 01010101, which is 0x55 in hexadecimal. In this arrangement, the Green diode is OFF when the Red diode is ON, and vice versa. As such, the pulses complement one another, with ON pulses of one diode chosen to correlate to OFF pulses of the other diode. As such, OFF time is minimized, yet further making it unlikely that flashing (and especially OFF pulses) can be detected during moving light effects. This embodiment also demonstrates that the octet pulsing approach enables the diode to start the cycle OFF and pulse ON one or more times during the cycle.

With reference next to FIG. 19, a table presents examples of some color mixtures created by varying the percent duty cycle of the Red, Green and Blue diodes of the LED bulb. The duty cycle for each color mixture is first presented as a duty cycle (percentage of cycle time ON) for each of the Red, Green and Blue diodes, and then represented as a binary representation of ON (“1”) and OFF (“0”) bits of the octet for each of the Red, Green and Blue diodes, and then represented as a hexadecimal representation with hexadecimal numbers corresponding to each nibble of the octet.

With continued reference to FIG. 19, in accordance with one embodiment, ON and OFF pulse timing for adjacent diodes preferably is selected to complement OFF and ON pulses of other diodes. For example, for the color mixture blush, the Red diode is always ON throughout the cycle. However, Green has only 2 ON pulses, and Blue has only 2 OFF pulses. Preferably the ON pulses of the Green diode are selected to complement and correspond to the OFF pulses of the Blue diode. Preferably a database is created to establish color mixtures in a manner so that such complementary pulse ON and OFF relationships are programmed into the color mixtures. As such, reduction of color aberrations such as flickering can be optimized.

With specific reference next to FIG. 20, each color mixture can be saved in a database 810 that corresponds the color mixture to the corresponding hexadecimal representation. For example, the preprogrammed colors of the microlights as listed in the table of FIG. 11B can be saved in a color database table 810 such as FIG. 20 in which each color is represented by a hexadecimal value corresponding to the control of two nibbles corresponding to each of the Red, Green and Blue diodes of the LED bulb in order to create the associated color mix.

The octet system for pulsing individual dies is particularly amenable to fast processing, enabling the processor to control the individual diodes while minimizing calculations. With reference next to FIGS. 20-25, operation and management of color information during a “play current mode” step 800 as discussed in the Flow Charts of FIGS. 9-15 according to some embodiments is illustrated.

When the play current mode step 800 is performed, a subroutine is performed to make playing the mode possible. For example, in the current embodiment, a first step is to identify the maximum number of colors 802 in the current mode. For purposes of illustration, and with additional reference to FIG. 21, the current embodiment depicts an embodiment similar to the microlight in FIGS. 15A-E, in which 5 default modes are provided, each having up to 7 colors. FIG. 21 depicts a table database 806 identifying the maximum colors in each of the five default modes. Here, for illustration we will select Mode 1, and thus the step of retrieving the maximum number of colors 802 in the mode selects “3” from the max colors database 806.

The next step prepares to retrieve the colors, and sets the process to receive the first color 804. The color is retrieved at step 808. Retrieving the colors involves accessing a database such as the saved colors database 812, such as represented by FIG. 22A or FIG. 22B. Preferably the saved colors database 812 includes default colors or, as in the illustrated embodiment, includes colors that have been previously set by the user. Specifically, FIG. 22A shows user-set colors by their associated color number and name (as depicted in the table of FIG. 11B).

FIG. 22B depicts the saved colors database 812 using a six-digit notation according to one embodiment. For example, the “red”, “sky blue” and “warm white” color mixtures are represented by six digits, with two digits each representing the hexadecimal code corresponding to the Red, Green and Blue diodes in order.

With reference again to FIG. 25, when each color is retrieved 808, the process queries whether the color retrieved was the last (max) color at 814. If not, the current color is set to the next color 816 and the next color is retrieved 808 from the databases 810, 812 until the last color 814 is retrieved.

Once colors are set, the method retrieves the relevant mode timing 818. This will involve accessing a mode timing database 820 such as the table in FIG. 23. The mode timing database 820 will include the ON and OFF time patterns of each mode. FIG. 23 presents ON and OFF times of several mode patterns in accordance with one embodiment. In the present embodiment, the Mode 1 timing is retrieved 818. Mode 1 is a Strobe mode having a repeating ON/OFF pattern of 5 ms ON and 8 ms OFF for each color.

Once the colors and timing have been retrieved, the play mode instruction 820 can be executed. In the method, the current color is set to the first color 822, which is then played 824 for the given ON time, followed by the OFF time 826. If the color is not the last color 828, the current color is set to the next color 830, which is played as at step 824. If the current color is the last color 828, the current color is reset to the first color 822 and again played 824. This loop proceeds until interrupted by, for example, actuation of the button.

In some embodiments, the data retrieved from the databases can be assembled into an instruction set as depicted in FIG. 24. As shown in the table of FIG. 24, a processor instruction set for playing the Mode 1 “3 color strobe” comprises playing the red color mixture, depicted with a hexadecimal code of FF0000 for 5 ms, then OFF for 8 ms, followed by the sky blue color mixture depicted with a hexadecimal code of 0092FF for 5 ms then OFF for 8 ms, followed by the warm white color mixture depicted with a hexadecimal code of BFEA10 for 5 ms then OFF for 8 ms, repeating until interrupted.

The six-digit hexadecimal codes in FIG. 24 are recognized by the processor as applying the first two digits to the hexadecimal code corresponding to the first and second nibbles of the Red diode binary octet; the third and fourth digits correspond to the hexadecimal codes of the first and second nibbles of the Green diode binary octet; and the fifth and sixth digits correspond to the hexadecimal codes of the first and second nibbles of the Blue diode binary octet. As such, pulse instructions can be provided quickly without substantial calculations by the processor.

The embodiments just discussed above, in which an octet byte made up of eight bits that each provide an ON or OFF instruction along a cycle need not only employ octets. Rather, an octet arrangement, specifically, is amenable to some chips, and particularly 8-bit chips. In other embodiments, other chips having other levels of sophistication, such as 32-bit chips, may be employed for certain LED-based moving light effects. It is anticipated that duty cycle of diodes can also be controlled in a similar manner, such as by employing 32-bit sets of instructions for each duty cycle rather than the 8-bit sets of instructions discussed above.

The embodiments described above have been described in the context of LED microlights for gloving. However, it is to be understood that the principles described herein can be applied to other products. For example, any and all of the routines described in association with FIG. 9-15 can be applied in other products configured to create moving light effects. For example, other LED-based moving light performance devices such as orbits, capsule pois, flowlights, lighted wands and sticks, and the like can benefit from the programmability depicted in those embodiments. In some embodiments, the moving light performance device may not require single-button actuation and programming, but may still benefit from the programmability of the discussed embodiments. As such, it is contemplated that some devices may or may not require single-button operation and programmability as discussed in the microlight embodiments.

It is also contemplated that light effects as discussed above can be incorporated into other devices, such as toys. Toys such as hula hoops, flying toys such as footballs, Frisbees and the like, and other toys that move during use can employ LEDs capable of creating the lighting effects and or programming as discussed herein.

Further, any application in which LEDs are in motion can employ the octet system for pulsing LEDs in connection with a duty cycle. For example, all of the moving-light performance- and toy-oriented devices just described may optionally include digital pulsing control of LEDs in connection with octets as discussed herein.

Other industrial devices can also benefit from the octet pulse control system. For example, in one embodiment LED-based automotive tail lights and/or headlights are controlled so that the brightness of the LEDs is controlled according to a desired duty cycle for, for example, running lights, brake lights, and high- and low-beam headlights. Such duty cycle control may or may not entail creating desired colors by controlled pulsing of different-colored LEDs, and may control brightness via varying duty cycle. However, employing distributed binary pulses of the LED in accordance with an octet-based control strategy as discussed herein can improve the smoothness of color emitted by the LED-based light fixture and perceived by an observer.

The embodiments discussed above have disclosed structures with substantial specificity. This has provided a good context for disclosing and discussing inventive subject matter. However, it is to be understood that other embodiments may employ different specific structural shapes and interactions.

Although inventive subject matter has been disclosed in the context of certain preferred or illustrated embodiments and examples, it will be understood by those skilled in the art that the inventive subject matter extends beyond the specifically disclosed embodiments to other alternative embodiments and/or uses of the invention and obvious modifications and equivalents thereof. In addition, while a number of variations of the disclosed embodiments have been shown and described in detail, other modifications, which are within the scope of the inventive subject matter, will be readily apparent to those of skill in the art based upon this disclosure. It is also contemplated that various combinations or subcombinations of the specific features and aspects of the disclosed embodiments may be made and still fall within the scope of the inventive subject matter. Accordingly, it should be understood that various features and aspects of the disclosed embodiments can be combined with or substituted for one another in order to form varying modes of the disclosed inventive subject matter. Thus, it is intended that the scope of the inventive subject matter herein disclosed should not be limited by the particular disclosed embodiments described above, but should be determined only by a fair reading of the claims that follow.

1. A microlight for gloving, comprising:
a casing configured to enclose a control chip having an integrated circuit and adapted to control a multicolor LED bulb, the casing sized to fit within a glove and adjacent a fingernail of a user wearing the glove; and
the casing having a top surface, a bottom surface and a generally rigid shell portion;
wherein a flexible bottom member is provided at the bottom surface of the casing, the flexible bottom member being more flexible than the rigid shell portion and configured to conform to a shape of a user's fingernail.

2. A microlight as in claim 1, wherein the casing has a bottom aperture, and the flexible bottom member extends across and seals the bottom aperture.

3. A microlight as in claim 2, wherein the casing has a top aperture, and a top flexible member extends across and seals the top aperture.

4. A microlight as in claim 3, wherein the top and bottom flexible members comprise an elastomer.

5. A microlight as in claim 4, wherein the top flexible member and the bottom flexible member are made of the same material.

6. A microlight as in claim 4, wherein the bottom flexible member is more flexible than the top flexible member.

7. A microlight as in claim 6, wherein the bottom flexible member has a coefficient of friction greater than a coefficient of friction of the top flexible member.

8. A microlight as in claim 1, wherein the microlight comprises a plurality of pre-programmed modes, and wherein the microlight comprises a routine for switching the microlight from a multi-mode operation, in which actuation of a button switches between the plurality of pre-programmed modes, to a one-mode operation, in which actuation of the button turns a single mode off and on.

9. A microlight as in claim 1, wherein the microlight is programmable to have up to a maximum number of color sets, and wherein each selected color can be selected to have one of at least two brightness levels.

10. A method of controlling a duty cycle of a light emitting diode (LED), comprising:
determining a desired duty cycle ON time per cycle for the LED;
dividing the ON and OFF time of the LED into at least one octet, the octet comprising 8 bits, each bit having a binary 1 corresponding to ON or a binary 0 corresponding to OFF, the total ON time of the octet corresponding to the desired ON duty cycle time; and
pulsing the LED ON during bits having a binary 1 and OFF during bits having a binary 0.

11. A method as in claim 10, additionally comprising providing an operational database in which the binary octet is saved, and retrieving the saved binary pattern.

12. A method as in claim 10, wherein if the desired duty cycle is less than 50%, no two adjacent bits have an ON setting.

13. A method as in claim 10 additionally comprising providing a second LED having a duty cycle, dividing the ON and OFF time of the second LED duty cycle into at least one octet, the octet comprising 8 bits, each bit having a binary 1 corresponding to ON or a binary 0 corresponding to OFF, the total ON time of the octet corresponding to the desired second LED ON duty cycle time, pulsing the second LED ON during bits having a binary 1 and OFF during bits having a binary 0, wherein at least one of the bits of the second LED having a binary 1 is timed to occur at the same time as at least one of the bits of the first LED having a binary 0.

14. A method as in claim 13 additionally comprising a table having a two digit hexadecimal code for each of the first and second LEDs, the first digit of the two-digit hexadecimal code corresponding to a hexadecimal number corresponding to a binary number representing the first binary nibble of the octet, the second digit of the two-digit hexadecimal code corresponding to a hexadecimal number corresponding to a binary number representing the second binary nibble of the octet.

15. A method of controlling a duty cycle of a light emitting diode (LED), comprising:
determining a desired duty cycle ON time per time cycle for the LED;
dividing the time cycle of the LED into a plurality of discrete successive time periods
assigning an ON or OFF instruction to each discrete time period so that the cumulative ON time per cycle equals the desired duty cycle ON time; and
performing the instruction of each discrete successive time period in order;
wherein performing the instruction comprises pulsing the LED ON only during time periods having the ON instruction.

16. A method as in claim 15, wherein the time cycle of the LED is divided into at least one octet having eight bits, and each bit corresponds to a discrete time period.

17. A method as in claim 16, wherein each ON bit stores a binary code of 1, and each OFF bit stores a binary code of 0.

18. A method as in claim 16, wherein the time cycle of the LED is divided into a plurality of octets.
